(19) United States
(12) Patent Application Publication
(10) Pub. No.: US 2020/0096745 A1
(43) Pub. Date: Mar. 26, 2020

(54) Lens Apparatus

(71) Applicants: Sintai Optical (Shenzhen) Co., Ltd., ShenZhen City (CN); Asia Optical Co., Inc., Taichung (TW)

(72) Inventors: Hsi-Ling Chang, Taichung (TW); Ming-Wei Shih, Taichung (TW); Guo-Quan Lin, ShenZhen City (CN)

(21) Appl. No.: 16/572,805

(22) Filed: Sep. 17, 2019

(30) Foreign Application Priority Data
Sep. 20, 2018 (CN) 201821547630.0
Oct. 8, 2018 (CN) 201821630327.7
Jul. 19, 2019 (TW) 108125681

(51) Int. Cl. G02B 13/00; G02B 27/64; G02B 7/09; G03B 5/04

(52) U.S. Cl. CPC G02B 13/0065; G03B 5/04; G02B 7/09; G02B 27/646

(57) ABSTRACT

A lens apparatus includes a lens driving module, a first reflecting element and a sensing element. The lens driving module includes a first lens unit, wherein the first lens unit includes a plurality of lenses, the lenses define an optical axis, one of the lenses has a maximal diameter, and another one of the lenses has a minimal diameter. The sensing element is disposed on an imaging plane of the lens apparatus. The first reflecting element is disposed between the lens driving module and the sensing element, the lens apparatus satisfies: 0.7 <(Pz/Ivz)<1.2, where Pz is a distance from an image side surface of one of the lenses closest to an image side to a reflecting surface of the first reflecting element along the optical axis, and Ivz is a length of the sensing element in a direction parallel to the optical axis.

### BACKGROUND OF THE INVENTION

### Field of the Invention

The invention relates to a lens apparatus, and more particularly to a lens apparatus having two reflecting elements.

### Description of the Related Art

Referring to FIG. 1, a conventional periscope lens apparatus 200 for a mobile phone sequentially includes, from an object side OBJ to an image side IMA, a prism PO, a plurality of lenses and a sensing element IP, wherein at least one of the lenses has a maximal effective diameter. In FIG. 1, the lens L1 of the lenses, which is closest to the image side IMA, has the maximal effective diameter.

However, the higher the resolution of the sensing element IP is, the larger the size of the sensing element IP is. In some cases, the size of the sensing element IP is even greater than the maximal effective diameter of the lens L1 in the lens apparatus 200, so that the lens apparatus 200 is large in thickness and thinning the periscope lens apparatus is difficult. Therefore, the thickness of a mobile phone provided with the conventional periscope lens apparatus cannot be decreased.

### BRIEF SUMMARY OF THE INVENTION

The invention provides a lens apparatus for solving the problem of thinning the lens apparatus described above. The lens apparatus of the invention can be provided with a high resolution sensing element while the thickness of the lens apparatus is not increased, so as to achieve the goal of thinning a lens apparatus with high pixels.

The lens apparatus in accordance with an embodiment of the invention from an object side to an image side along an optical axis sequentially includes a lens driving module, a first reflecting element and a sensing element. The lens driving module includes a first lens unit, wherein the first lens unit includes a plurality of lenses, the lenses define the optical axis, one of the lenses has a maximal effective diameter CAB, and another one of the lenses has a minimal effective diameter CAS. The sensing element is disposed on an imaging plane of the lens apparatus. The first reflecting element is disposed between the lens driving module and the sensing element, the lens apparatus satisfies: 0.7<(Pz/Ivz)<1.2, where Pz is a distance from an image side surface of one of the lenses closest to the image side to a reflecting surface of the first reflecting element along the optical axis, and Ivz is a length of the sensing element in a direction parallel to the optical axis.

In another embodiment, the lens apparatus further includes a second reflecting element disposed between the object side and the lens driving module.

In yet another embodiment, the lens apparatus further satisfies: CAS/2<Py <CAB, where Py is a vertical distance from a reflecting point of the first reflecting element to the sensing element, and the optical axis passes through the reflecting point.

In another embodiment, the lens driving module further includes a first fixing element and a first carrier, the first carrier is configured to fix and carry the first lens unit, is disposed on the first fixing element and is movable with respect to the first fixing element in a Z-direction, and the Z-direction is parallel to the optical axis.

In yet another embodiment, the lens driving module, the first reflecting element, and the sensing element are sequentially arranged in the direction of the optical axis.

In another embodiment, the lens apparatus further includes an optical stabilizing module including a second lens unit, a second fixing element and a second carrier, the second carrier is configured to fix the second lens unit, is disposed on the second fixing element and is movable with respect to the second fixing element in a X-direction and a Y-direction, and the Z-direction, the X-direction and the Y-direction are perpendicular to each other.

In yet another embodiment, the lens apparatus further includes a housing, wherein the lens driving module and the second reflecting element are fixed in the housing, the housing includes a bottom plate and a top plate disposed with respect to each other, a length of the bottom plate is smaller than a length of the top plate in the Z-direction.

In another embodiment, a bottom of the housing is provided with an inserting opening, and the top plate of the housing is provided with a light entering opening corresponding to the inserting opening.

In yet another embodiment, the housing further includes a plurality of gluing holes corresponding to the second reflecting element.

In another embodiment, the lens driving module is configured to drive the lenses to move in a direction perpendicular to a Y-direction, the Y-direction is perpendicular to a receiving plane of the sensing element, a Z-direction is parallel to the optical axis, a X-direction is perpendicular to the Z-direction and the Y-direction, and the Z-direction, the X-direction and the Y-direction are perpendicular to each other.

In yet another embodiment, the first reflecting element is a prism or reflecting mirror.

In another embodiment, the second reflecting element is a prism or reflecting mirror.

In yet another embodiment, the lens apparatus further includes a second reflecting element driver configured to drive the second reflecting element to rotate about the X-direction or the Y-direction.

In another embodiment, the lens driving module further includes a lens driver configured to drive the lenses, the second reflecting element driver is a prism driver.

In yet another embodiment, the lens driver includes a magnet and a coil, and the magnet and the coil are disposed with respect to each other.

In another embodiment, the lens apparatus further includes a first reflecting element driver configured to drive the first reflecting element to move in a direction perpendicular to a plane of the sensing element.

In yet another embodiment, the lens apparatus further includes a first reflecting element driver configured to drive the first reflecting element to move in the direction parallel to the optical axis.

A detailed description is given in the following embodiments with reference to the accompanying drawings.

### BRIEF DESCRIPTION OF THE DRAWINGS

The invention can be more fully understood by reading the subsequent detailed description and examples with references made to the accompanying drawings, wherein:

FIG. 1 is a schematic view of a conventional lens apparatus;

FIG. 2A is a schematic view of a lens apparatus in accordance with a first embodiment of the invention;

FIG. 2B is a schematic view of a lens apparatus in accordance with a second embodiment of the invention;

FIG. 2C is a schematic view of a lens apparatus in accordance with a third embodiment of the invention;

FIG. 2D is a schematic view of a lens apparatus in accordance with a fourth embodiment of the invention;

FIG. 2E is another schematic view of the lens apparatus of FIG. 2D;

FIG. 3A is an optical schematic view of the lens apparatus in accordance with the first embodiment of the invention;

FIG. 3B is an optical schematic view of the lens apparatus in accordance with the second embodiment of the invention;

FIG. 3C is an optical schematic view of the lens apparatus in accordance with the third embodiment of the invention.

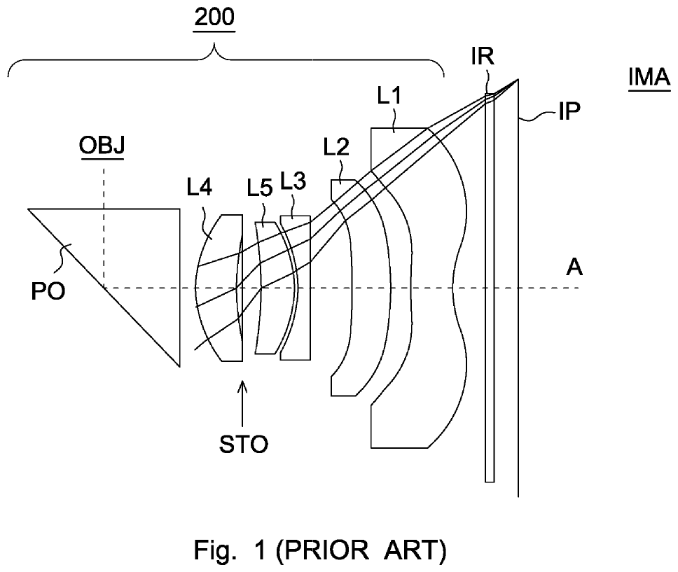

### DETAILED DESCRIPTION OF THE INVENTION

In the description of the invention, it is to be understood that the terms “central”, “longitudinal”, “traverse”, “upper”, “lower”, “front”, “rear”, “left”, “right”, “vertical”, “horizontal”, “top”, “bottom”, “inner”, “outer”, clockwise”, “counterclockwise” and so on, are used for indicating the orientations or positions based on the relationship of elements shown in the drawings for convenience and simplification of description only, without indicating or implying that the device or elements referred thereto must have a particular orientation and the orientation of a particular configuration and operation, and thus those should not be construed as limiting the invention.

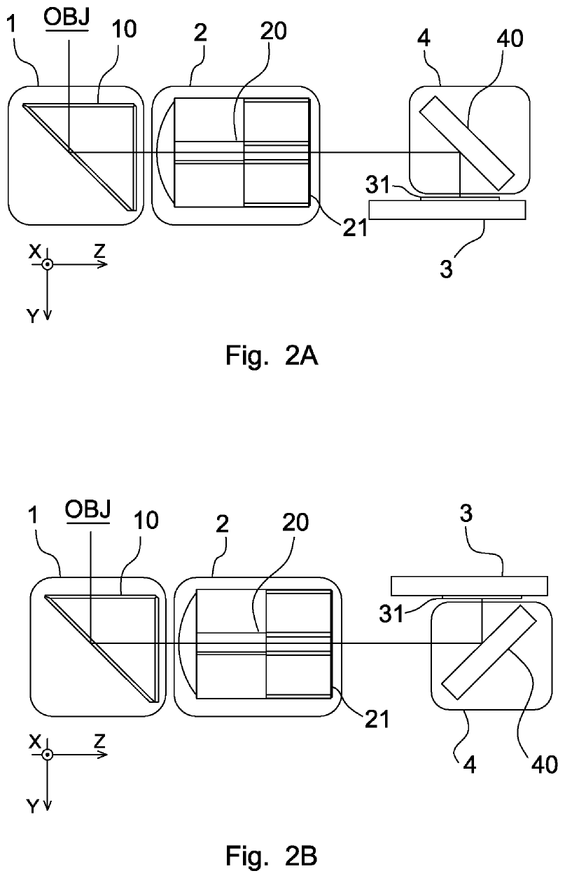

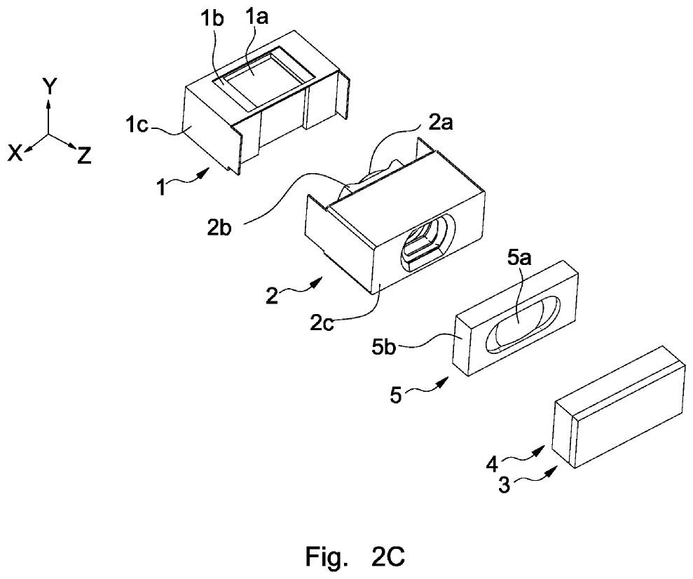

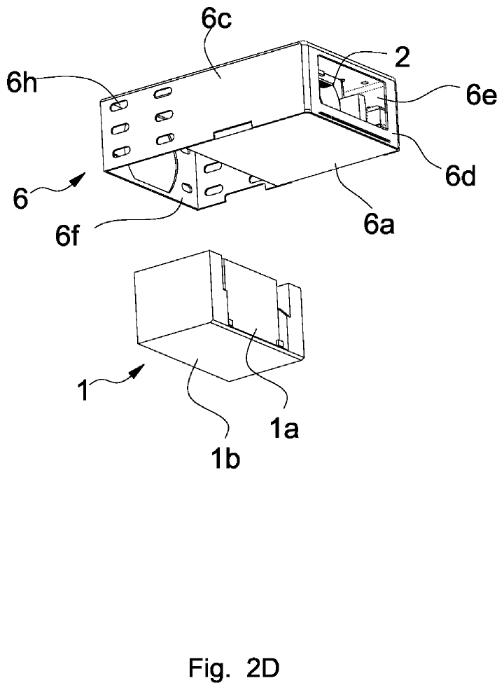

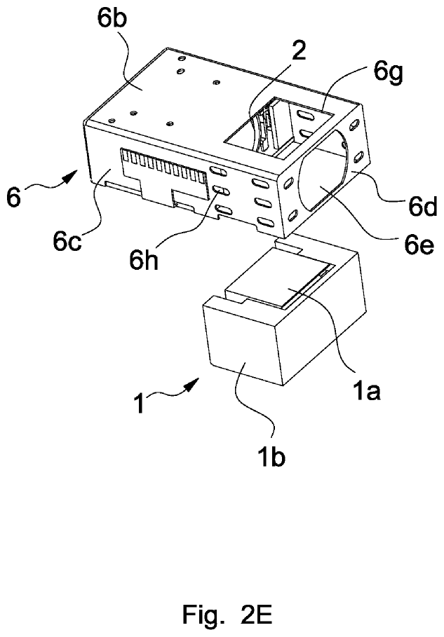

Referring to FIG. 2A, a periscope lens apparatus in accordance with a first embodiment of the invention includes a second reflecting element driving module 1, a lens driving module 2, a first reflecting element driving module 4 and a sensing element 3 configured to sense light, wherein the second reflecting element driving module 1 includes a second reflecting element 10 configured to change an optical path of light entering the lens apparatus in a Y-direction and a second reflecting element carrier (not shown) configured to carry the second reflecting element 10. The lens driving module 2 includes a first lens unit 20 configured to allow light to pass through. The first reflecting element driving module 4 includes a first reflecting element 40 configured to change an optical path of light passing through the first lens unit 20 for directing the light to the sensing element 3. The lens driving module 2 is disposed between the second reflecting element driving module 1 and the sensing element 3. The light entering the lens apparatus sequentially passes through the second reflecting element driving module 1, the lens driving module 2 and the first reflecting element driving module 4 for entering a sensing element 3.

The second reflecting element 10 changes the optical path of the light entering the lens apparatus for directing the light to travel in a Z-direction and enter the lens driving module 2. The second reflecting element driving module 1, the lens driving module 2 and the first reflecting element driving module 4 are sequentially arranged in the Z-direction.

As shown in FIG. 2A, the sensing element 3 includes a receiving plane 31 configured to receiving light, the first lens unit 20 includes a light-exiting plane 21 configured to allow light to pass through, and the receiving plane 31 of the sensing element 3 is perpendicular to the light-exiting plane 21 of the first lens unit 20. That is, the light passing through the first lens unit 20 is parallel to the receiving plane 31. The first reflecting element 40 is disposed at a side of the sensing element 3 provided with the receiving plane 31. In the first embodiment, the light-exiting plane 21 of the first lens unit 20 is erected and faces towards the right side. That is, the light-exiting plane 21 faces the first reflecting element driving module 4 and the sensing element 3. The sensing element 3 is flat placed on bottom side, and the receiving plane 31 of the sensing element 3 faces towards the upper side. That is, the receiving plane 31 of the sensing element 3 faces the first reflecting element 40. The sensing element 3 and the first reflecting element 40 are disposed with respect to each other, and the first reflecting element 40 is located above the sensing element 3.

The second reflecting element 10 is firmly disposed with respect to the second reflecting element carrier. In such arrangement, the second reflecting element 10 is not rotatable, thereby increasing reliability thereof. The lens driving module 2 further includes a lens driver (not shown) configured to drive the first lens unit 20. The first lens unit 20 is driven by the lens driver to move in the Z-direction, so as to achieve function of auto focus (AF). The first reflecting element 40 is rotatable about an X-direction and the Y-direction for achieving multidirectional rotation. The first reflecting element 40 is close to the sensing element 3, so that the first reflecting element 40 can be slightly adjusted in angle thereof for achieving function of optical image stabilization (OIS).

The Y-direction, the Z-direction and the X-direction are perpendicular to each other. During operation, light emitted by an object travels in the Y-direction and enters the second reflecting element driving module 1. The optical path is changed by the second reflecting element 10 of the second reflecting element driving module 1 wherein the light is changed to travel in the Z-direction and enters the lens driving module 2. The light travels from the first lens unit 20 of the lens driving module 2 to the first reflecting element driving module 4 in the Z-direction. The optical path is changed by the first reflecting element 40 of the first reflecting element driving module 4, wherein the light is changed to travel in the Y-direction and enters the sensing element 3.

The second reflecting element driving module 1, the lens driving module 2 and the first reflecting element driving module 4 are sequentially arranged in the Z-direction, while the first reflecting element driving module 4 and the sensing element 3 are sequentially arranged in the Y-direction.

The lens driving module 2 includes a lens driver (not shown) configured to drive the first lens unit 20. In the first embodiment, the lens driver is a linear voice coil motor. The first lens unit 20 is disposed on a carrier (not shown) on which the linear voice coil motor is disposed, and the lens driver includes a magnet (not shown) and a coil (not shown) for driving the first lens unit 20 to move in the Z-direction, wherein the magnet and the coil are disposed with respect to each other. In other words, the lens driver is configured to drive the first lens unit 20 to move in the Z-direction. The first reflecting element driving module 4 further includes a first reflecting element driver (not shown) configured to drive the first reflecting element 40.

The first reflecting element 40 of the first reflecting element driving module 4 can be rotated or moved by the first reflecting element driver. For example, the first reflecting element 40 is driven to rotate about the X-direction or the Y-direction, or the first reflecting element 40 is driven to move in a direction. It is understood that the first reflecting element 40 can be firmly fixed from rotation and movement.

The linear voice coil motor can be substituted by a swing-type voice coil motor. Both the linear voice coil motor and the swing-type voice coil motor are believed well known to those skilled in the art, and therefore the descriptions thereof are omitted. It is worth noting that a piezoelectric material can be substituted for the voice coil motor to drive the first lens unit 20, first reflecting element 40 or the second reflecting element 10.

FIG. 2B depicts a lens apparatus in accordance with a second embodiment of the invention, wherein the receiving plane 31 of the sensing element 3 and the light-exiting plane 21 of the first lens unit 20 are perpendicular to each other. That is, the light passing through the first lens unit 20 is parallel to the receiving plane 31. The first reflecting element 40 is disposed at a side of the sensing element 3 provided with the receiving plane 31. In the second embodiment, the light-exiting plane 21 of the first lens unit 20 is erected and faces towards the right side. That is, the light-exiting plane 21 faces the first reflecting element driving module 4 and the sensing element 3. The sensing element 3 is flat placed on the bottom side, and the receiving plane 31 of the sensing element 3 faces towards the lower side. That is, the receiving plane 31 of the sensing element 3 faces the first reflecting element 40. The sensing element 3 and the first reflecting element 40 are disposed with respect to each other, and the sensing element 3 is located above the first reflecting element 40.

Referring to FIG. 2C, a lens apparatus in accordance with a third embodiment of the invention includes a second reflecting element driving module 1, a lens driving module 2, an optical stabilizing module 5, a first reflecting element driving module 4 and a sensing element 3, wherein the second reflecting element driving module 1, the lens driving module 2, the optical stabilizing module 5, the first reflecting element driving module 4 and the sensing element 3 are sequentially arranged in the Z-direction. As shown in FIG. 2C, the first reflecting element driving module 4 and the sensing element 3 are assembled to be a single element. The lens driving module 2 defines an optical axis extending in the Z-direction. The arrangement of the second reflecting element driving module 1, the lens driving module 2, the optical stabilizing module 5, the first reflecting element driving module 4 and the sensing element 3 can be identical or similar to those of the first embodiment (FIG. 2A) or the second embodiment (FIG. 2B) described above, and therefore the descriptions thereof are omitted.

The second reflecting element driving module 1 includes a second reflecting element 1a, a second reflecting element carrier 1bconfigured to fix and carry the second reflecting element 1a and a second reflecting element fixing element 1c. In a selectable embodiment, the second reflecting element carrier 1bis fixed in the second reflecting element fixing element 1c. In another selectable embodiment, the second reflecting element carrier 1b is disposed in the second reflecting element fixing element 1c through a rotating shaft (not shown) extending in the X-direction, and the second reflecting element driving module 1 further includes a second reflecting element driver (not shown), wherein the second reflecting element driver is an electromagnetic device and is configured to drive the second reflecting element carrier 1b to rotate about the rotating shaft by means of electromagnetic force.

The light entering the lens apparatus in the Y-direction is reflected by the second reflecting element driving module 1, travels in the Z-direction, and sequentially passes through the lens driving module 2, the optical stabilizing module 5, the first reflecting element driving module 4 and the sensing element 3. The Y-direction is perpendicular to the X-direction and the Z-direction. The second reflecting element carrier 1b is able to rotate about the rotating shaft, thereby adjusting the direction in which the light travels to the lens driving module 2.

The lens driving module 2 includes a first lens unit 2a, a first carrier 2b configured to fix and carry the first lens unit 2a and a first fixing element 2c. The first carrier 2b is disposed on the first fixing element 2c and can be moved with respect to the first fixing element 2c in the Z-direction for focusing, so that a clear image can be formed on the sensing element 3. There are many ways to place the first carrier 2b on the first fixing element 2c. For example, the first fixing element 2c is provided with a first guiding shaft (not shown) extending in the Z-direction, and the first carrier 2b is provided with a first through hole (not shown) corresponding to the first guiding shaft and is disposed on the first fixing element 2c by inserting the first guiding shaft into the first through hole. The lens driving module 2 further includes a lens driver, wherein the lens driver is an electromagnetic device and is configured to drive the first carrier 2b to move along the first guiding shaft by means of electromagnetic force.

The optical stabilizing module 5 includes a second lens unit 5a, a second carrier (not shown) configured to fix the second lens unit 5a and a second fixing element 5b. In a condition that the function of optical image stabilization (OIS) is not executed, the second lens unit 5a also defines an optical axis extending in the Z-direction. The second carrier is disposed on the second fixing element 5b and can be moved with respect to the second fixing element 5b in the X-direction and the Y-direction. In a selectable embodiment, the second fixing element 5b is provided with a second guiding shaft (not shown) extending in the X-direction, and the second carrier is provided with a second through hole (not shown) extending in the X-direction. The second through hole is elongated, wherein a length of the second through hole in the Y-direction is greater than a diameter of the second guiding shaft. The second carrier is movably disposed on the second fixing element 5b by inserting the second guiding shaft into the second through hole. The optical stabilizing module 5 further includes a first OIS driver (not shown) and a second OIS driver (not shown), wherein the first OIS driver includes a magnet disposed on one of the second carrier and the second fixing element 5b and a coil correspondingly disposed on the other one of the second carrier and the second fixing element 5b. The arrangement of the second OIS driver is similar to those of the first OIS driver, and therefore the descriptions thereof are omitted. The first OIS driver and the second OIS driver are configured to drive the second carrier to move with respect to the second fixing element 5b respectively in the X-direction and the Y-direction, so that image blurring caused by vibrations can be improved.

The lens apparatus further includes a controller and a sensor, wherein the controller is connected to the second reflecting element driver, the lens driver, the first OIS driver, the second OIS driver and the sensor, so as to control the above described elements. Moreover, the controller is configured to control the first OIS driver and the second OIS driver according to a vibration signal emitted by the sensor. The operation of the controller (e.g. receiving signal, controlling driver) is believed well known to those skilled in the art, and therefore the descriptions thereof are omitted.

During assembly, the second reflecting element fixing element 1cof the second reflecting element driving module 1, the first fixing element 2c of the lens driving module 2, the second fixing element 5b of the optical stabilizing module 5, the first reflecting element driving module 4 and the sensing element 3 are sequentially fixed together by, for example, adhesive.

The lens apparatus of the third embodiment is provided with the optical stabilizing module 5 and can compensate for effect of vibrations by only the optical stabilizing module 5 and therefore has better reliability and controllability of optical stabilization than a conventional lens apparatus in which the functions of auto focus (AF) and optical image stabilization (OIS) are both achieved by a lens driving module (or the function of optical image stabilization (OIS) is achieved by a second reflecting element driving module).

Referring to FIGS. 2D and 2E, a lens apparatus in accordance with a fourth embodiment of the invention includes a second reflecting element driving module 1, a lens driving module 2, an optical stabilizing module (not shown), a first reflecting element driving module (not shown), a sensing element (not shown), and a housing 6. The arrangement of the second reflecting element driving module 1, the lens driving module 2, the optical stabilizing module, the first reflecting element driving module and the sensing element is similar to that of the first or second embodiment described above, and therefore the descriptions thereof are omitted. As shown in FIGS. 2D and 2E, the second reflecting element driving module 1 includes a second reflecting element 1a and a second reflecting element carrier 1b configured to fix and carry the second reflecting element 1a.

The housing 6 is cuboid and includes a bottom plate 6a, a top plate 6b, a frontal side plate 6c, a rear side plate 6c, a left side plate 6d and a right side plate 6d, wherein the bottom plate 6a and the top plate 6b are disposed with respect to each other, the frontal side plate 6c and the rear side plate 6c are connected to the bottom plate 6a and the top plate 6b, and the left side plate 6d and the right side plate 6d are also connected to the bottom plate 6a and the top plate 6b. The frontal side plate 6c and the rear side plate 6c are parallel to the Z-direction, and the left side plate 6d and the right side plate 6d are perpendicular to the Z-direction. The left side plate 6d and the right side plate 6d are provided with openings 6e. A length of the bottom plate 6a is smaller than a length of the top plate 6b in the Z-direction, so that an inserting opening 6f is formed on a bottom of the housing 6 for allowing an entry of the second reflecting element driving module 1 into the housing 6. The top plate 6b of the housing 6 is provided with a light entering opening 6g corresponding to the inserting opening 6f During operation, light traveling in the Y-direction enters the light entering opening 6g, is reflected by the second reflecting element driving module 1 to travel in the Z-direction and sequentially passes through the lens driving module 2 and the optical stabilizing module for entering the sensing element.

The second reflecting element driving module 1 and the lens driving module 2 are firmly disposed in the housing 6 and can be fixed by adhesive. During assembly, the second reflecting element driving module 1 is placed into the housing 6 thorugh the inserting opening 6f After the second reflecting element driving module 1 and the lens driving module 2 are aligned with each other, the second reflecting element driving module 1 and the lens driving module 2 are fixed by adhesive. The frontal side plate 6c and the rear side plate 6c are provided with a plurality of gluing holes 6h corresponding to the second reflecting element driving module 1. The adhesive is adhered to the second reflecting element driving module 1 through the gluing holes 6h, so that the second reflecting element driving module 1 is further fixed.

In the fourth embodiment, the second reflecting element driving module 1 and the lens driving module 2 are fixed in the same housing 6, so as to improve reliability of the lens apparatus. Moreover, the first reflecting element driving module can also be fixed in the housing 6 or outside the housing 6.

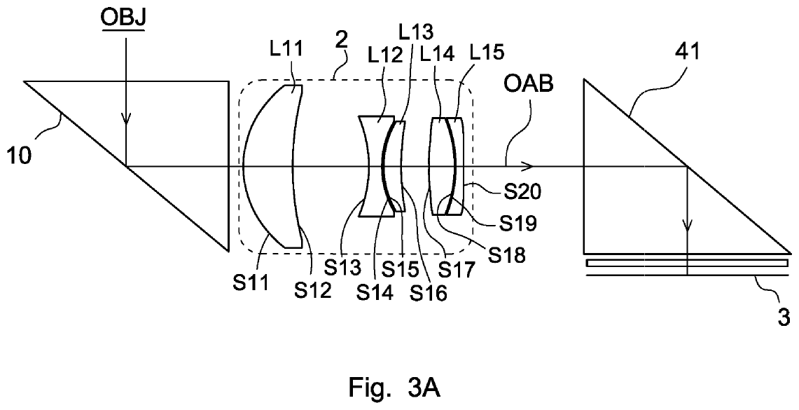

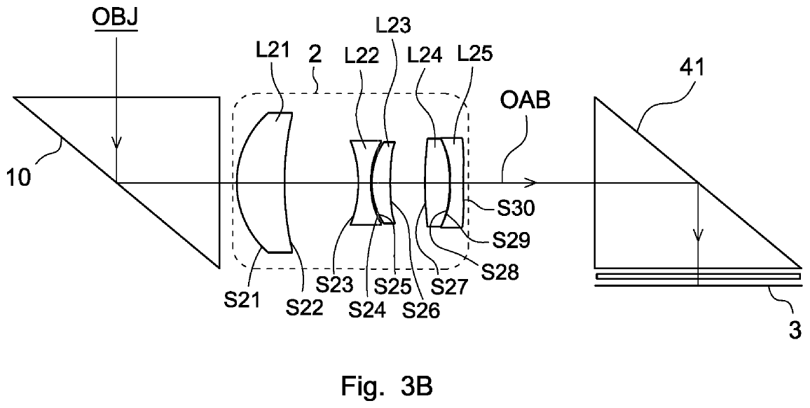

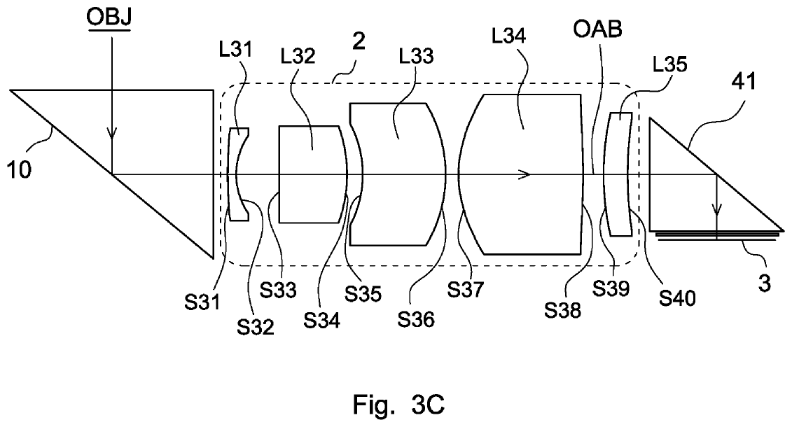

Referring to FIG. 3A, FIG. 3A is an optical schematic view of the lens apparatus in accordance with the first embodiment of the invention. The lens apparatus in accordance with the first embodiment of the invention sequentially includes, from an object side OBJ to an image side, a second reflecting element 10, a lens driving module 2, a first reflecting element 41 and a sensing element 3 disposed on an imaging plane of the lens apparatus. The second reflecting element 10 is part of a second reflecting element driving module, and the first reflecting element 41 is part of a first reflecting element driving module. During operation, the light OAB enters the second reflecting element 10 through the object side OBJ and is reflected by the second reflecting element 10 to pass through the lens driving module 2. Then, the light OAB enters the first reflecting element 41, is reflected by the first reflecting element 41 and enters the sensing element 3.

The lens driving module 2 includes a plurality of lenses, wherein the lenses define an optical axis. The lenses sequentially includes, from the object side OBJ to the sensing element 3, a first lens L11 having positive refractive power, a second lens L12 negative refractive power, a third lens L13 having positive refractive power, a fourth lens L14 having positive refractive power and a fifth lens L15 having negative refractive power. The first lens L11 includes a convex surface S11 facing the object side OBJ and a concave surface S12 facing the image side. The second lens L12 includes a concave surface S13 facing the object side OBJ and a concave surface S14 facing the image side. The third lens L13 includes a convex surface S15 facing the object side OBJ and a concave surface S16 facing the image side. The fourth lens L14 includes a convex surface S17 facing the object side OBJ and a convex surface S18 facing the image side. The fifth lens L15 includes a concave surface S19 facing the object side OBJ and a concave surface S20 facing the image side. The lens apparatus of the first embodiment satisfies 0.7<(Pz/Ivz)<1.2, where Pz is a distance from an image side surface of one of the lenses closest to the image side (that is, the concave surface S20 of the fifth lens L15) to a reflecting surface of the first reflecting element 41 along the optical axis, and Ivz is a length of the sensing element 3 in a direction parallel to the optical axis.

The first lens L11 of the lenses has a maximal effective diameter CAB, and the third lens L13 of the lenses has a minimal effective diameter CAS. Therefore, the lens apparatus of the first embodiment further satisfies: CAS/2<Py<CAB, where Py is a vertical distance from a reflecting point of the first reflecting element 41 to the sensing element 3, and the optical axis passes through the reflecting point.

Referring to Table 1, Table 1 shows several parameters related to the lens apparatus of FIG. 3A.

TABLE 1
Effective focal length = 15.000 mm
f-number = 2.69
Total length = 16.627457 mm
field of view = 22 degrees

| | Radius of | | Refractive | Abbe | Effective | |
|---|---|---|---|---|---|---|
| Reference | curvature | Thickness | index | number | diameter | |
| number | (mm) | (mm) | Nd | Vd | (mm) | Memo |
| OBJ | ∞ | ∞ | | | | |
| S11 | 3.784334 | 1.433 | 1.68548 | 54.62 | 5.56 | CAB = 5.56 |
| S12 | 11.09087 | 1.87754 | | | 5.2 | |
| STO | | 0.33839 | | | | |
| S13 | 3.508988 | 0.381 | 1.66134 | 20.3729 | 3.427049 | |
| S14 | 4.564805 | 0.0274 | | | 3.092157 | |
| S15 | 3.515976 | 0.512 | 1.53522 | 56.1153 | 3.101503 | |
| S16 | 15.88092 | 0.80265 | | | 3.053535 | CAS = 3.053535 |
| S17 | 8.284338 | 0.76 | 1.66134 | 20.3729 | 3.28 | |
| S18 | −5.928196 | 0.01542 | | | 3.33 | |
| S19 | −7.285505 | 0.244 | 1.53522 | 56.1153 | 3.33 | |
| S20 | 50.5587 | 3.5 | | | 3.336 | |
| | ∞ | 3 | 1.74001 | 28.2915 | 6 | The first |
| | ∞ | 3 | | | 6 | reflecting |
| | | | | | | element 10 |
| | | 0.2 | | | | Air |
| | ∞ | 0.21 | 1.5168 | 64.127 | 5.760952 | Light filter |
| | ∞ | 0.32605 | | | 5.80761 | (not shown) |
| | | | | | 5.866 | Sensing |
| | | | | | | element 3 |

An aspheric surface sag z of each lens in Table 1 can be calculated from following equation:

z=ch²/{<1−(k+1) c²h²]^{1/2}}+Ah⁴+Bh⁶+Ch⁸+Dh¹⁰+Eh¹²+Fh¹⁴+Gh¹⁶+Hh¹⁸, where c is a curvature, h is a vertical distance from a point on surface of the lens to the optical axis, k is a conic constant, and A, B, C, D, E, F, G and H are aspheric coefficients.

Referring to Table 2, Table 2 shows several parameters related to the aspheric surface of each lens in Table 1, wherein k is the conic constant, and A, B, C, D, E, F, G and H are aspheric coefficients.

TABLE 2

| Surface | | A | B | C | D |
|---|---|---|---|---|---|
| Number | k | E | F | G | H |
| S11 | 0.09643472 | 0 | −0.000455251 | 6.66E−05 | −1.83E−05 |
| | | 1.67E−06 | −5.48E−08 | −3.19E−09 | −1.69E−09 |
| S12 | 0.00E+00 | 0 | −0.00058112 | 3.13E−05 | 1.58E−05 |
| | | −5.91E−06 | 4.89E−07 | −4.92E−08 | 2.84E−09 |
| S13 | 0.00E+00 | 0 | 0.0204211 | −0.001563449 | −0.000390386 |
| | | 0.000110598 | 1.60E−05 | −4.22E−06 | 8.72E−08 |
| S14 | 5.508209 | 0 | 0.012309509 | −0.006616706 | −0.000303134 |
| | | −5.37E−06 | 0.000159802 | 4.30E−05 | −2.90E−05 |
| S15 | 1.410546 | 0 | 0.003268566 | −0.005233348 | 0.000136692 |
| | | −0.000229391 | 0.000247724 | 9.37E−05 | −5.27E−05 |
| S16 | 63.79342 | 0 | 0.00176682 | 0.002596601 | 0.000523897 |
| | | −0.000668693 | 0.00021675 | 5.05E−05 | −3.39E−05 |
| S17 | 4.887451 | 0 | −0.013861826 | 0.00147422 | 0.00044261 |
| | | 0.000105256 | −9.62E−05 | 7.45E−06 | −2.65E−06 |
| S18 | −14.04705 | 0 | −0.022264288 | 0.002909766 | 0.001694 |
| | | 0.000187206 | −0.000296595 | 2.27E−05 | 6.24E−06 |
| S19 | −1.106341 | 0 | −0.0304701 | 0.007853715 | 0.00076484 |
| | | −0.000713952 | 0.000163914 | −3.88E−05 | 1.03E−05 |
| S20 | −8665.493 | 0 | −0.016555082 | 0.004541824 | −0.00167109 |
| | | 0.000293334 | 4.05E−05 | −5.82E−06 | −7.87E−07 |

As shown in Table 1, CAB=5.56 mm, CAS=3.053535 mm, Pz=6.5 mm, Py=3.736051 mm and Ivz=5.866 mm. Therefore, Pz/Ivz=1.10808. It shows that the lens apparatus of the first embodiment satisfies 0.7<(Pz/Ivz) <1.2. Moreover, CAS/2=1.5267675 mm. It shows that the lens apparatus of the first embodiment satisfies CAS/2<Py<CAB.

Referring to FIG. 3B, FIG. 3B is an optical schematic view of the lens apparatus in accordance with the second embodiment of the invention. The lens apparatus in accordance with the second embodiment of the invention sequentially includes, from an object side OBJ to an image side, a second reflecting element 10, a lens driving module 2, a first reflecting element 41 and a sensing element 3 disposed on an imaging plane of the lens apparatus. The second reflecting element 10 is part of a second reflecting element driving module, and the first reflecting element 41 is part of a first reflecting element driving module. During operation, the light OAB enters the second reflecting element 10 through the object side OBJ and is reflected by the second reflecting element 10 to pass through the lens driving module 2. Then, the light OAB enters the first reflecting element 41, is reflected by the first reflecting element 41 and enters the sensing element 3.

The lens driving module 2 includes a plurality of lenses, wherein the lenses define an optical axis. The lenses sequentially includes, from the object side OBJ to the sensing element 3, a first lens L21 having positive refractive power, a second lens L22 negative refractive power, a third lens L23 having positive refractive power, a fourth lens L24 having positive refractive power and a fifth lens L25 having negative refractive power. The first lens L21 includes a convex surface S21 facing the object side OBJ and a concave surface S22 facing the image side. The second lens L22 includes a concave surface S23 facing the object side OBJ and a concave surface S24 facing the image side. The third lens L23 includes a convex surface S25 facing the object side OBJ and a concave surface S26 facing the image side. The fourth lens L24 includes a convex surface S27 facing the object side OBJ and a convex surface S28 facing the image side. The fifth lens L25 includes a concave surface S29 facing the object side OBJ and a concave surface S30 facing the image side. The lens apparatus of the second embodiment satisfies 0.7<(Pz/Ivz) <1.2, where Pz is a distance from an image side surface of one of the lenses closest to the image side (that is, the concave surface S30 of the fifth lens L25) to a reflecting surface of the first reflecting element 41 along the optical axis, and Ivz is a length of the sensing element 3 in a direction parallel to the optical axis.

The first lens L21 of the lenses has a maximal effective diameter CAB, and the second lens L22 of the lenses has a minimal effective diameter CAS. Therefore, the lens apparatus of the second embodiment further satisfies CAS/2<Py<CAB, where Py is a vertical distance from a reflecting point of the first reflecting element 41 to the sensing element 3, and the optical axis passes through the reflecting point.

Referring to Table 3, Table 3 shows several parameters related to the lens apparatus of FIG. 3B.

TABLE 3
Effective focal length = 21.900 mm
f-number = 3.4
Total length = 22.66369 mm
field of view = 22.6 degrees

| | Radius of | | Refractive | Abbe | Effective | |
|---|---|---|---|---|---|---|
| Reference | curvature | Thickness | index | number | diameter | |
| number | (mm) | (mm) | Nd | Vd | (mm) | Memo |
| OBJ | ∞ | ∞ | | | | |
| S21 | 4.821897 | 1.842933 | 1.68548 | 54.62 | 6.448 | CAB = 6.448 |
| S22 | 14.54267 | 2.424636 | | | 6.177044 | |
| STO | | 0.445573 | | | | |
| S23 | −4.59456 | 0.483656 | 1.66134 | 20.3729 | 3.897557 | |
| S24 | 5.964493 | 0.034275 | | | 3.709908 | |
| S25 | 4.444313 | 0.714694 | 1.53522 | 56.1153 | 3.769446 | |
| S26 | 19.00414 | 1.336355 | | | 3.71912 | CAS = 3.709908 |
| S27 | 12.09981 | 0.964773 | 1.66134 | 20.3729 | 4.011425 | |
| S28 | −7.94303 | 0.019042 | | | 4.074048 | |
| S29 | −9.53993 | 0.507775 | 1.53522 | 56.1153 | 4.078199 | |
| S30 | 27.15887 | 5.1 | | | 4.11298 | |
| | ∞ | 4 | 1.74001 | 28.2915 | 8 | The first |
| | ∞ | 4 | | | 8 | reflecting |
| | | | | | | element 10 |
| | | 0.253888 | | | | Air |
| | ∞ | 0.21 | 1.5168 | 64.127 | 7.766638 | Light filter |
| | ∞ | 0.326087 | | | 7.848 | (not shown) |
| | | | | | 7.994294 | Sensing |
| | | | | | | element 3 |

Definition of an aspheric surface sag z of each lens in Table 3 is similar to that of Table 1 described above, and therefore the descriptions thereof are omitted.

Referring to Table 4, Table 4 shows several parameters related to the aspheric surface of each lens in Table 3, wherein k is a conic constant, and A, B, C, D, E, F, G and H are aspheric coefficients.

TABLE 4

| Surface | | A | B | C | D |
|---|---|---|---|---|---|
| Number | k | E | F | G | H |
| S21 | 0.07836996 | 0 | −2.73E−04 | 1.17E−05 | −2.75E−06 |
| | | 1.92E−07 | −3.60E−09 | −5.80E−11 | −2.94E−11 |
| S22 | 0.00E+00 | 0 | −0.000410434 | 1.33E−05 | 3.84E−06 |
| | | −6.00E−07 | 3.83E−08 | −2.38E−09 | 6.18E−11 |
| S23 | 0.00E+00 | 0 | 2.67E−02 | −0.001886362 | −4.80E−04 |
| | | 1.26E−04 | 1.44E−05 | −5.94E−06 | 2.13E−07 |
| S24 | 5.583157 | 0 | 1.59E−02 | −0.007686294 | −2.02E−04 |
| | | 2.06E−06 | 2.12E−04 | 6.30E−05 | −3.35E−05 |
| S25 | 1.224735 | 0 | 4.94E−03 | −0.005959682 | 4.53E−04 |
| | | −1.99E−04 | 3.44E−04 | 1.34E−05 | −5.75E−05 |
| S26 | 70.95511 | 0 | 4.27E−03 | 0.003574595 | 5.16E−04 |
| | | −7.64E−04 | 3.43E−04 | 7.87E−05 | −3.90E−05 |
| S27 | 2.611164 | 0 | −1.73E−02 | 0.00164858 | 6.00E−04 |
| | | 1.57E−04 | −1.27E−04 | 1.66E−05 | 3.09E−06 |
| S28 | −8.341728 | 0 | −2.87E−02 | 0.003479004 | 1.51E−03 |
| | | 2.04E−04 | −3.41E−04 | 4.77E−05 | 7.95E−06 |
| S29 | 3.98063 | 0 | −4.21E−02 | 0.009552096 | 1.25E−03 |
| | | −8.17E−04 | 1.87E−04 | −6.00E−05 | 1.14E−05 |
| S30 | −715.6282 | 0 | −2.08E−02 | 0.005745142 | −1.88E−03 |
| | | 3.85E−04 | 2.74E−05 | −2.00E−05 | −2.89E−07 |

As shown in Table 3, CAB=6.448 mm, CAS=3.709908 mm, Pz=9.1 mm, Py=4.789974 mm and Ivz=7.994294 mm. Therefore, Pz/Ivz=1.138312. It shows that the lens apparatus of the second embodiment satisfies 0.7<(Pz/Ivz) <1.2. Moreover, CAS/2=1.854954 mm. It shows that the lens apparatus of the second embodiment satisfies CAS/2 <Py<CAB.

Referring to FIG. 3C, FIG. 3C is an optical schematic view of the lens apparatus in accordance with the third embodiment of the invention. The lens apparatus in accordance with the third embodiment of the invention sequentially includes, from an object side OBJ to an image side, a second reflecting element 10, a lens driving module 2, a first reflecting element 41 and a sensing element 3 disposed on an imaging plane of the lens apparatus. The second reflecting element 10 is part of a second reflecting element driving module, and the first reflecting element 41 is part of a first reflecting element driving module. During operation, the light OAB enters the second reflecting element 10 through the object side OBJ and is reflected by the second reflecting element 10 to pass through the lens driving module 2. Then, the light OAB enters the first reflecting element 41, is reflected by the first reflecting element 41 and enters the sensing element 3.

The lens driving module 2 includes a plurality of lenses, wherein the lenses define an optical axis. The lenses sequentially includes, from the object side OBJ to the sensing element 3, a first lens L31 having negative refractive power, a second lens L32 positive refractive power, a third lens L33 having negative refractive power, a fourth lens L34 having positive refractive power and a fifth lens L35 having positive refractive power. The first lens L31 includes a convex surface S31 facing the object side OBJ and a concave surface S32 facing the image side. The second lens L32 includes a concave surface S33 facing the object side OBJ and a convex surface S34 facing the image side. The third lens L33 includes a concave surface S35 facing the object side OBJ and a convex surface S36 facing the image side. The fourth lens L34 includes a convex surface S37 facing the object side OBJ and a convex surface S38 facing the image side. The fifth lens L35 includes a convex surface S39 facing the object side OBJ and a concave surface S40 facing the image side. The lens apparatus of the third embodiment satisfies 0.7<(Pz/Ivz) <1.2, where Pz is a distance from an image side surface of one of the lenses closest to the image side (that is, the concave surface S40 of the fifth lens L35) to a reflecting surface of the first reflecting element 41 along the optical axis, and Ivz is a length of the sensing element 3 in a direction parallel to the optical axis.

The fourth lens L34 of the lenses has a maximal effective diameter CAB, and the second lens L32 of the lenses has a minimal effective diameter CAS. Therefore, the lens apparatus of the third embodiment further satisfies: CAS/2<Py<CAB, where Py is a vertical distance from a reflecting point of the first reflecting element 41 to the sensing element 3, and the optical axis passes through the reflecting point.

Referring to Table 5, Table 5 shows several parameters related to the lens apparatus of FIG. 3C.

TABLE 5
Effective focal length = 8.04 mm
f-number = 1.45
Total length = 50.80 mm
field of view = 70 degrees

| | Radius of | | Refractive | Abbe | Effective | |
|---|---|---|---|---|---|---|
| Reference | curvature | Thickness | index | number | diameter | |
| number | (mm) | (mm) | Nd | Vd | (mm) | Memo |
| OBJ | ∞ | ∞ | | | | |
| S31 | 71.82297 | 0.727936 | 1.66134 | 34.476 | 9.897279 | CAB = 7.240997 |
| S32 | 8.624238 | 3.509072 | | | 8.458493 | |
| STO | | 0.373358 | | | | |
| S33 | −542.047 | 6.067105 | 1.66134 | 20.3729 | 7.240997 | |
| S34 | −17.9727 | 1.4236 | | | 10.31849 | |
| S35 | −10.5334 | 7.406668 | 1.66134 | 20.3729 | 10.8893 | |
| S36 | −16.4316 | 1.151018 | | | 15.06081 | CAS = 16.92893 |
| S37 | 14.92712 | 11.15383 | 1.86112 | 40.28003 | 16.92893 | |
| S38 | −91.5255 | 1.850235 | | | 14.65744 | |
| S39 | 32.22476 | 2.145768 | 1.66134 | 20.3729 | 13.06543 | |
| S40 | 97.8929 | 2 | | | 12 | |
| | ∞ | 6 | 1.74001 | 28.2915 | 12 | The first |
| | ∞ | 6 | | | 12 | reflecting |
| | | | | | | element 10 |
| | | 0.253888 | | | | Air |
| | ∞ | 0.21 | 1.5168 | 64.127 | 10.92158 | Light filter |
| | ∞ | 0.507524 | | | 10.90173 | (not shown) |
| | | | | | 10.4 | Sensing |
| | | | | | | element 3 |

Definition of an aspheric surface sag z of each lens in Table 5 is similar to that of Table 1 described above, and therefore the descriptions thereof are omitted.

Referring to Table 6, Table 6 shows several parameters related to the aspheric surface of each lens in Table 5, wherein k is a conic constant, and A, B, C, D, E, F, G and H are aspheric coefficients.

TABLE 6

| Surface | | A | B | C | D |
|---|---|---|---|---|---|
| Number | k | E | F | G | H |
| S31 | 21.97914 | 0 | 3.57E−05 | 3.22E−07 | 8.16E−09 |
| | | 5.22E−10 | 1.28E−11 | 4.63E−13 | 0 |
| S32 | 0.02418986 | 0 | 0.000117648 | 1.95E−06 | −9.77E−08 |
| | | −7.26E−10 | −8.56E−11 | −2.99E−12 | 0 |
| S33 | 100.0001 | 0 | −0.000119459 | 8.09E−07 | −1.62E−08 |
| | | −4.48E−09 | −1.40E−10 | 0 | 0 |
| S34 | 0.3358382 | 0 | −6.64E−05 | 2.22E−06 | −6.44E−08 |
| | | −1.22E−10 | 6.58E−12 | 0 | 0 |
| S35 | −5.375755 | 0 | −0.000103659 | 4.79E−06 | −8.34E−08 |
| | | 8.67E−11 | 1.39E−12 | 5.97E−15 | 6.20E−16 |
| S36 | 0.0035578 | 0 | 2.68E−05 | −2.20E−07 | −3.60E−09 |
| | | 3.26E−11 | 6.09E−14 | −3.13E−15 | 1.29E−17 |
| S37 | −1.080261 | 0 | −3.69E−05 | 1.76E−07 | 7.69E−11 |
| | | −3.44E−12 | 8.50E−15 | 0 | 0 |
| S38 | −1206.341 | 0 | −1.50E−05 | −1.45E−07 | 1.41E−09 |
| | | −4.15E−12 | −1.67E−14 | 0 | 0 |
| S39 | 0.3836496 | 0 | 0.000115632 | −5.12E−06 | 4.71E−08 |
| | | −1.37E−10 | −1.58E−13 | −1.27E−16 | 0 |
| | −100.0006 | 0 | 0.000296684 | −5.44E−06 | −5.49E−08 |
| | | −2.26E−10 | 3.85E−13 | 9.70E−15 | 0 |

As shown in Table 5, CAB=16.92893 mm, CAS=7.240997 mm, Pz=8.0 mm, Py=6.9714116 mm and Ivz=10.4 mm. Therefore, Pz/Ivz=0.76923. It shows that the lens apparatus of the third embodiment satisfies 0.7<(Pz/Ivz) <1.2. Moreover, CAS/2=3.6204985 mm. It shows that the lens apparatus of the third embodiment satisfies CAS/2<Py<CAB.

In the invention, the Y-direction, the Z-direction and the Z-direction are perpendicular to each other, wherein the Y-direction is perpendicular to the receiving plane 31 of the sensing element 3, and the Z-direction is parallel to the optical axis and is penetrated through the lens driving module 2.

The second reflecting element driving module 1 further includes a second reflecting element driver (not shown) configured to drive the second reflecting element 10. The first reflecting element 40 of the first reflecting element driving module 4 also can be fixed (or stably disposed) from rotation and movement.

In the invention, the second reflecting element driver is a swing-type voice coil motor, and the second reflecting element 10 is disposed on a carrier (not shown) on which the swing-type voice coil motor is disposed. The swing-type voice coil motor includes a magnet (not shown) and a coil (not shown), wherein the magnet and the coil are configured to drive the second reflecting element 10 to rotate about the X-direction or the Y-direction and are disposed with respect to each other. In other words, the second reflecting element driver is configured to drive the second reflecting element 10 to rotate about the X-direction or the Y-direction.

In the invention, the lens driver is a linear voice coil motor, and the first lens unit 20 is disposed on a carrier (not shown) on which the linear voice coil motor is disposed. The linear voice coil motor includes a magnet (not shown) and a coil (not shown), wherein the magnet and the coil are configured to drive the first lens unit 20 to move in the Z-direction (or the Z-direction and the Y-direction, or the Z-direction and the X-direction) and are disposed with respect to each other. In other words, when the second reflecting element driver drives the second reflecting element 10 to rotate about the X-direction, the lens driver drives the first lens unit 20 to move in the X-direction and/or the Z-direction. When the second reflecting element driver drives the second reflecting element 10 to rotate about the Y-direction, the lens driver drives the first lens unit 20 to move in the Y-direction and/or the Z-direction. Moreover, the lens driver can drive the first lens unit 20 to move in the Z-direction, the Y-direction and the Z-direction.

In the invention, when the second reflecting element driver drives the second reflecting element 10 to rotate about the X-direction as well as the lens driver drives the first lens unit 20 to move in the X-direction, the first reflecting element driver (not shown) drives the first reflecting element to move in the Y-direction or the Z-direction for adjusting the focal length of the lens apparatus. In the invention, when the second reflecting element driver drives the second reflecting element 10 to rotate about the Y-direction as well as the lens driver drives the first lens unit 20 to move in the Y-direction, the first reflecting element driver (not shown) drives the first reflecting element to move in the Y-direction or the Z-direction. In the invention, when the lens driver drives the first lens unit 20 to move in the Z-direction, the first reflecting element of the first reflecting element driving module 4 is fixed (or stably disposed) from rotation and movement.

Both the linear voice coil motor and the swing-type voice coil motor are believed well known to those skilled in the art, and therefore the descriptions thereof are omitted. It is worth noting that a piezoelectric material can be substituted for the voice coil motor to drive the first lens unit 20, the second reflecting element 10 or the first reflecting element.

In the invention, the first reflecting element 41 is a reflecting mirror or prism, and the second reflecting element 10 also is a reflecting mirror or prism.

While the invention has been described by way of example and in terms of preferred embodiment, it is to be understood that the invention is not limited thereto. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A lens apparatus, from an object side to an image side along an optical axis, sequentially comprising:
a lens driving module comprising a first lens unit, wherein the first lens unit comprises a plurality of lenses, the lenses define the optical axis, one of the lenses has a maximal effective diameter CAB, and another one of the lenses has a minimal effective diameter CAS;
a first reflecting element; and
a sensing element disposed on an imaging plane of the lens apparatus;
wherein the first reflecting element is disposed between the lens driving module and the sensing element, and the lens apparatus satisfies 0.7 <(Pz/Ivz) <1.2, where Pz is a distance from an image side surface of one of the lenses closest to the image side to a reflecting surface of the first reflecting element along the optical axis, and Ivz is a length of the sensing element in a direction parallel to the optical axis.

2. The lens apparatus as claimed in claim 1, further comprising a second reflecting element disposed between the object side and the lens driving module.

3. The lens apparatus as claimed in claim 2, wherein the lens apparatus further satisfies CAS/2<Py<CAB, where Py is a vertical distance from a reflecting point of the first reflecting element to the sensing element, and the optical axis passes through the reflecting point.

4. The lens apparatus as claimed in claim 3, wherein the lens driving module further comprises a first fixing element and a first carrier, the first carrier is configured to fix and carry the first lens unit, is disposed on the first fixing element and is movable with respect to the first fixing element in a Z-direction, and the Z-direction is parallel to the optical

5. The lens apparatus as claimed in claim 4, wherein the lens driving module, the first reflecting element, and the sensing element are sequentially arranged in the direction of the optical axis.

6. The lens apparatus as claimed in claim 4, wherein the lens apparatus further comprises an optical stabilizing module comprising a second lens unit, a second fixing element and a second carrier, the second carrier is configured to fix the second lens unit, is disposed on the second fixing element and is movable with respect to the second fixing element in a X-direction and a Y-direction, and the Z-direction, the X-direction and the Y-direction are perpendicular to each other.

7. The lens apparatus as claimed in claim 6, further comprising a housing, wherein the lens driving module and the second reflecting element are fixed in the housing, the housing comprises a bottom plate and a top plate disposed with respect to each other, a length of the bottom plate is smaller than a length of the top plate in the Z-direction.

8. The lens apparatus as claimed in claim 7, wherein a bottom of the housing is provided with an inserting opening, and the top plate of the housing is provided with a light entering opening corresponding to the inserting opening.

9. The lens apparatus as claimed in claim 8, wherein the housing further comprises a plurality of gluing holes corresponding to the second reflecting element.

10. The lens apparatus as claimed in claim 2, wherein the lens driving module is configured to drive the lenses to move in a direction perpendicular to a Y-direction, the Y-direction is perpendicular to a receiving plane of the sensing element, a Z-direction is parallel to the optical axis, a X-direction is perpendicular to the Z-direction and the Y-direction, and the Z-direction, the X-direction and the Y-direction are

11. The lens apparatus as claimed in claim 10, wherein the first reflecting element is a prism or reflecting mirror.

12. The lens apparatus as claimed in claim 11, wherein the second reflecting element is a prism or reflecting mirror.

13. The lens apparatus as claimed in claim 10, further comprising a second reflecting element driver configured to drive the second reflecting element to rotate about the X-direction or the Y-direction.

14. The lens apparatus as claimed in claim 13, wherein the lens driving module further comprises a lens driver configured to drive the lenses, the second reflecting element driver is a prism driver.

15. The lens apparatus as claimed in claim 14, wherein the lens driver comprises a magnet and a coil, and the magnet and the coil are disposed with respect to each other.

16. The lens apparatus as claimed in claim 10, further comprising a first reflecting element driver configured to drive the first reflecting element to move in a direction perpendicular to a plane of the sensing element.

17. The lens apparatus as claimed in claim 10, further comprising a first reflecting element driver configured to drive the first reflecting element to move in the direction parallel to the optical axis.
